(19) United States
(12) Patent Application Publication
(10) Pub. No.: US 2014/0021188 A1
(43) Pub. Date: Jan. 23, 2014

(54) HOT-WIRE CONSUMABLE TO PROVIDE WELD WITH INCREASED WEAR RESISTANCE

(71) Applicant: LINCOLN GLOBAL, INC., City of Industry, CA (US)

(72) Inventor: Paul Edward Denney, Bay Village, OH (US)

(73) Assignee: LINCOLN GLOBAL, INC., City of Industry, CA (US)

(21) Appl. No.: 13/842,188

(22) Filed: Mar. 15, 2013

Related U.S. Application Data
(63) Continuation-in-part of application No. 13/789,205, filed on Mar. 7, 2013.
(60) Provisional application No. 61/673,496, filed on Jul. 19, 2012.

(51) Int. Cl. B23K 35/02

(52) U.S. Cl. CPC B23K 35/0261
USPC 219/146.31

(57) ABSTRACT

A filler wire (consumable) for depositing wear-resistant materials in a system for any of brazing, cladding, building up, filling, hard-facing overlaying, welding, and joining applications is provided. The consumable is composed of base filler materials consistent with commonly known compositions. For example, the base filler material can comprise standard materials used in many standard mild steel wires. In addition to the base filler materials, the consumable includes wear-resistant materials. The wear-resistant materials include at least one of amorphous metallic powder, diamond crystals, diamond powder, tungsten carbide, and aluminides.

### PRIORITY

The present application is a continuation-in-part of and claims priority to U.S. patent application Ser. No. 13/789,205 filed Mar. 7, 2013, which claims priority to U.S. Provisional patent application 61/673,496 filed Jul. 19, 2012 of which are incorporated herein by reference in their entirety.

### TECHNICAL FIELD

Certain embodiments relate to a filler wire used in overlaying, welding, and joining applications. More particularly, certain embodiments relate to a system and method that uses a filler wire to deposit wear-resistant material in a system for any of brazing, cladding, building up, filling, hard-facing overlaying, joining, and welding applications.

### BACKGROUND

In traditional arc welding or surfacing (cladding, etc.) operations a filler wire may be used to deposit material into the joint using a high temperature arc. Heat from the arc melts the filler wire and the melted filler wire droplets are added to the weld puddle. However, because of the presence of the arc the composition of the filler wire can be limited as certain materials and compositions do not transfer easily, or at all, with the use of an arc. This can be due to a number of reasons, including the high temperature of the arc or due to the arc/plasma dynamics present in the arc. However, it is very desirable to have some of these components deposited into a surfacing operation or weld joint and as such there is a need to be able to use filler wires with various compositions and components therein.

Further limitations and disadvantages of conventional, traditional, and proposed approaches will become apparent to one of skill in the art, through comparison of such approaches with embodiments of the present invention as set forth in the remainder of the present application with reference to the drawings.

### SUMMARY

Embodiments of the present invention comprise a system and method to use at least one filler wire to deposit wear-resistant material in a system for any of brazing, cladding, building up, filling, hard-facing overlaying, welding, and joining applications.

The method also includes applying energy from a high intensity energy source to the workpiece to heat the workpiece at least while using a laser to heat the at least one filler wire. The high intensity energy source may include at least one of a laser device, a plasma arc welding (PAW) device, a gas tungsten arc welding (GTAW) device, a gas metal arc welding (GMAW) device, a flux cored arc welding (FCAW) device, and a submerged arc welding (SAW) device.

These and other features of the claimed invention, as well as details of illustrated embodiments thereof, will be more fully understood from the following description and drawings.

### BRIEF DESCRIPTION OF THE DRAWINGS

The above and/or other aspects of the invention will be more apparent by describing in detail exemplary embodiments of the invention with reference to the accompanying drawings, in which:

FIG. 1 illustrates a functional schematic block diagram of an exemplary embodiment of a combination filler wire feeder and energy source system for any of brazing, cladding, building up, filling, hard-facing overlaying, welding, and joining applications;

FIGS. 2A-B illustrate exemplary embodiments of filler wires that can be used in the system of FIG. 1;

FIGS. 3A-B illustrate exemplary embodiments of filler wires that can be used in the system of FIG. 1;

FIG. 4 illustrates an exemplary embodiment of a filler wire that can be used in the system of FIG. 1;

FIG. 5A illustrates a cross-sectional view of an exemplary weld that can be formed using the exemplary embodiments of filler wires illustrated in FIGS. 2A and 3A;

FIG. 5B illustrates a cross-sectional view of an exemplary weld that can be formed using the filler wires illustrated in FIGS. 2B and 3B;

FIG. 6 illustrates a cross-sectional view of an exemplary weld that can be formed using the filler wires illustrated in FIG. 4;

FIG. 7 illustrates a functional schematic block diagram of an exemplary embodiment of a combination filler wire feeder and energy source system for any of brazing, cladding, building up, filling, hard-facing overlaying, welding, and joining applications;

FIGS. 8A and 8B depict exemplary cladding layers depicting use of embodiments of the present invention;

FIGS. 9 and 10 illustrate exemplary embodiments of a filler wire that can be used in the system of FIG. 1.

### DETAILED DESCRIPTION

Exemplary embodiments of the invention will now be described below by reference to the attached Figures. The described exemplary embodiments are intended to assist in the understanding of the invention, and are not intended to limit the scope of the invention in any way. Although much of the following discussions will reference “welding” operations and systems, embodiments of the present invention are not just limited to joining operations, but can similarly be used for cladding, brazing, overlaying, etc.—type operations. Like reference numerals refer to like elements throughout.

Welding/joining operations typically join multiple workpieces together in a welding operation where a filler metal is combined with at least some of the workpiece metal to form a joint. In such operations, the filler material may not be of the exact composition as the workpieces. Accordingly, it is not uncommon for the joint to have properties that are different as compared to the rest of the workpiece. For example, the joint may be more susceptible to wear, whereas the workpiece is made of a material that is wear resistant. In such cases, it would be desirable to have the joint composed of materials that are at least as wear resistant as the workpiece. However, because the traditional methods use an arc to transfer the filler material, the ability to add wear-resistant materials to the filler material may be limited as these materials may get consumed in the arc, rather than being deposited in the weld puddle. As described below, exemplary embodiments of the present invention can deposit wear-resistant materials into the weld and provide significant advantages over existing welding technologies.

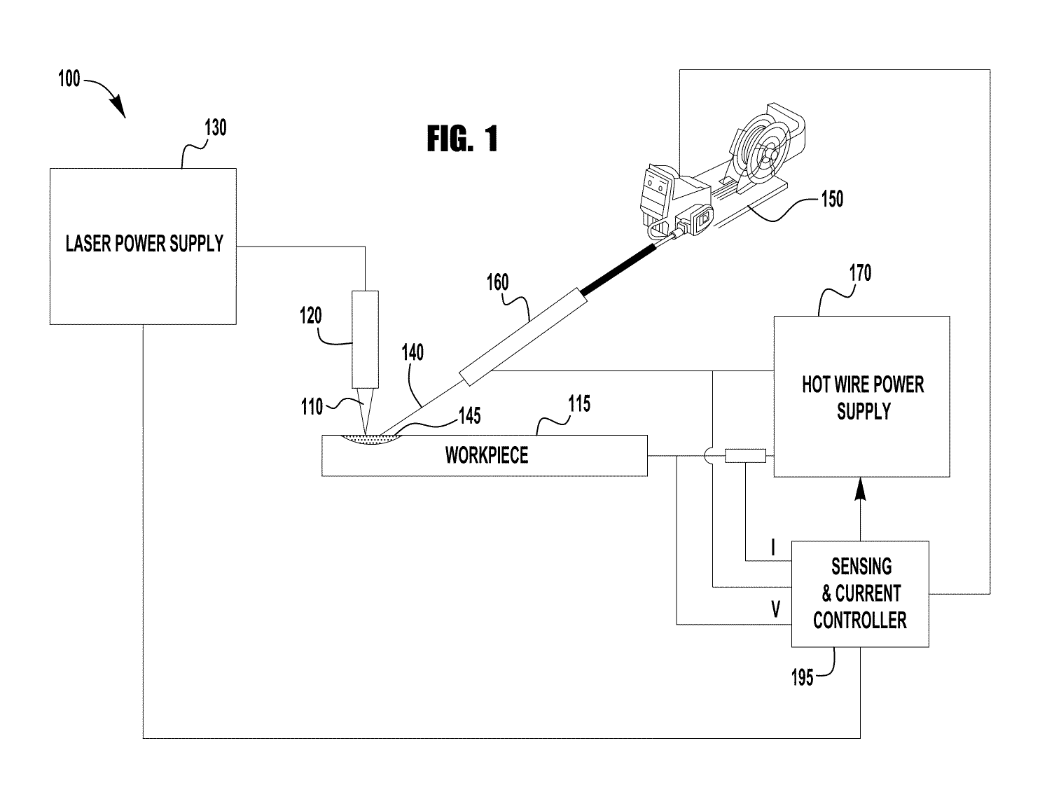

FIG. 1 illustrates a functional schematic block diagram of an exemplary embodiment of a combination filler wire feeder and energy source system 100 for performing any of brazing, cladding, building up, filling, hard-facing overlaying, and joining/welding applications. The system 100 includes a high energy heat source capable of heating the workpiece 115 to form a weld puddle 145. The high energy heat source can be a laser subsystem 130/120 that includes a laser device 120 and a laser power supply 130 operatively connected to each other. The laser 120 is capable of focusing a laser beam 110 onto the workpiece 115 and the power supply 130 provides the power to operate the laser device 120. The laser subsystem 130/120 can be any type of high energy laser source, including but not limited to carbon dioxide, Nd:YAG, Yb-disk, YB-fiber, fiber delivered, or direct diode laser systems. Further, even white light or quartz laser type systems can be used if they have sufficient energy. For example, a high intensity energy source can provide at least 500 W/cm².

The following specification will repeatedly refer to the laser subsystem 130/120, beam 110 and laser power supply 130, however, it should be understood that this reference is exemplary as any high intensity energy source may be used. For example, other embodiments of the high energy heat source may include at least one of an electron beam, a plasma arc welding subsystem, a gas tungsten arc welding subsystem, a gas metal arc welding subsystem, a flux cored arc welding subsystem, and a submerged arc welding subsystem. It should be noted that the high intensity energy sources, such as the laser device 120 discussed herein, should be of a type having sufficient power to provide the necessary energy density for the desired welding operation. That is, the laser device 120 should have a capability to modify the energy from the laser power supply (or other source) to create and maintain a stable weld puddle throughout the welding process, and also reach the desired weld penetration. For example, for some applications, lasers should have the ability to “keyhole”1 into the workpieces being welded. This means that the laser should have sufficient power density to penetrate (partially or fully) into the workpiece, while maintaining that level of penetration as the laser travels along the workpiece. Exemplary lasers should have power capabilities in the range of 1 to 20 kW, and may have a power capability in the range of 5 to 20 kW. In other exemplary embodiments, the power density can be in the range of 10⁵ to 10⁸ watts/cm². Higher power lasers can be utilized, but can become very costly.

The system 100 also includes a hot filler wire feeder subsystem capable of providing at least one filler wire 140 to make contact with the workpiece 115 in the vicinity of the laser beam 110. Of course, it is understood that by reference to the workpiece 115 herein, the molten puddle, i.e., weld puddle 145, is considered part of the workpiece 115, thus reference to contact with the workpiece 115 includes contact with the puddle 145. The hot filler wire feeder subsystem includes a filler wire feeder 150, a contact tube 160, and a hot wire power supply 170. In accordance with an embodiment of the present invention, the hot wire welding power supply 170 is a direct current (DC) power supply (that can be pulsed, for example), although alternating current (AC) or other types of power supplies are possible as well. The wire 140 is fed from the filler wire feeder 150 through the contact tube 160 toward the workpiece 115 and extends beyond the tube 160. During operation, the extension portion of the filler wire 140 is resistance-heated by an electrical current from the hot wire welding power supply 170, which is operatively connected between the contact tube 160 and the workpiece 115. Prior to its entry into the weld puddle 145 on the workpiece 115, the extension portion of the wire 140 may be resistance-heated such that the extension portion approaches or reaches the melting point before contacting the weld puddle 145 on the workpiece 115. Because the filler wire 140 is heated to at or near its melting point, its presence in the weld puddle 145 will not appreciably cool or solidify the puddle 145 and the wire 140 is quickly consumed into the weld puddle 145. The laser beam 110 (or other energy source) serves to melt some of the base metal of the workpiece 115 to form the weld puddle 145 and complete the melting of the wire 140 onto the workpiece 115. However, the power supply 170 provides the energy needed to resistance-heat the filler wire 140 to or near a molten temperature.

The system 100 also includes sensing and control unit 195. The sensing and control unit 195 can be operatively connected to the power supply 170, the wire feeder 150, and/or the laser power supply 130 to control the welding process in system 100. U.S. patent application Ser. No. 13/212,025, titled “Method And System To Start And Use Combination Filler Wire Feed And High Intensity Energy Source For Welding” is incorporated by reference in its entirety, provides exemplary startup and post-startup control algorithms that may be incorporated in sensing and control unit 195 for operating system 100.

Unlike most welding processes, the present invention melts the filler wire 140 into the weld puddle 145 rather than using a welding arc to heat, melt and transfer the filler wire 140 into the weld puddle 145. Because no arc is used to transfer of the filler wire 140 in the process described herein, the filler wire can include materials that normally would be consumed in, or interact with the arc in such a manner as to not exist in the puddle following solidification. For example, the filler wire 140 may include wear-resistant materials such as diamonds, tungsten carbide, aluminides, etc. in order to increase the wear resistance of the weld. These structures, due to heating or chemical activity in the arc, may change their structure, composition, and/or properties.

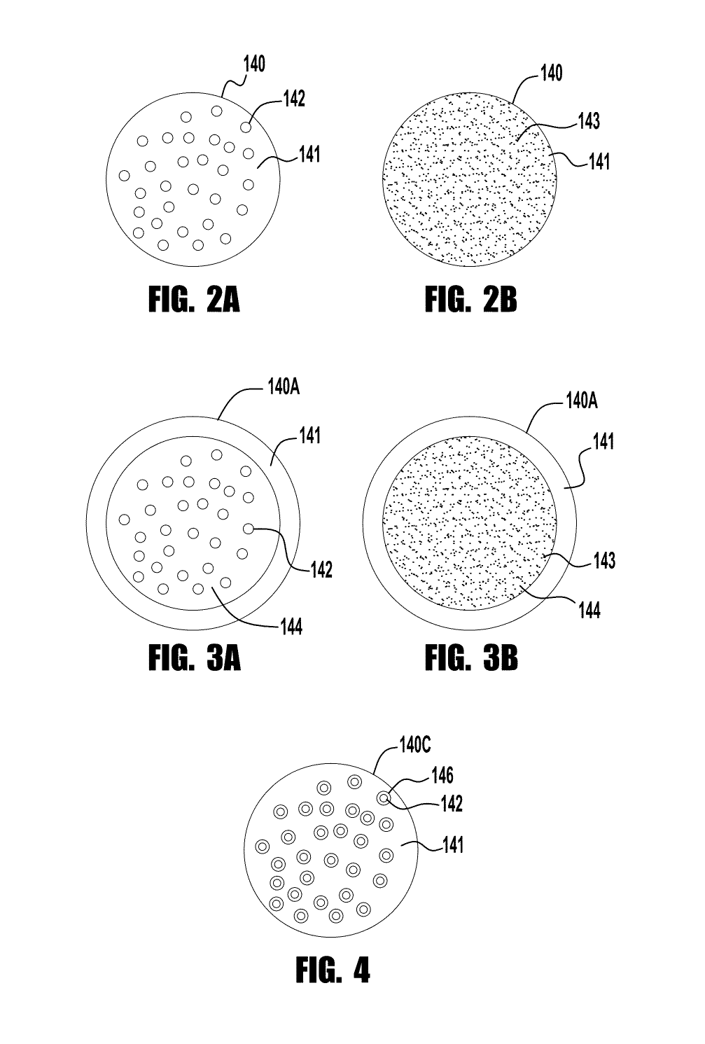

In exemplary embodiments of the present invention, the wear-resistant material is composed of small diamond crystals. As shown in FIG. 2A, the filler wire 140 is composed of the base filler material 141, which can be any standard filler material that is appropriate for the weld process. Embedded in the base filler material 141 are diamond crystals 142 that can have a nominal diameter of, for example, in the range of 5 microns to 200 microns. Of course, other particle sizes can be used without departing from the scope of the present invention, so long as the particles can be deposited and provide the desired performance. The density of the diamond crystals 142 in filler material 141 will depend on environment that the workpiece will see. For example, the density of diamonds 142 in filler material 141 will be higher for a workpiece that is exposed to a highly abrasive environment than for a workpiece that is in a less abrasive environment. In exemplary embodiments of the present invention, the volume percent of diamonds in the wire 140 will be in the range of 5%-30%. However, embodiments can have different density depending on the environment for the completed workpiece. In other exemplary embodiments, such as that shown in FIG. 2B, diamond powder 143 is mixed with the filler material 141 to produce the filler wire 140. Of course, the filler wire 140 may include a combination of diamond crystals 142 and diamond powder 143. The filler wire 140, with the embedded diamond crystals 142 and/or diamond powder 143, may be manufactured using known methods such as combining the diamond crystals or diamond powder with filler metal powder and then sintering them. The type of diamond is not limiting and can be natural or synthetic. It should be noted that although the following discussion often refers to “diamond” this is merely intended to be exemplary as other wear resistant materials can be used.

In the above embodiments, the diamond crystals 142 and/or diamond powder 143 are mixed or embedded in the base filler material 141 composition and manufactured similar to that of a solid-type filler wire. However, in some embodiments of the present invention, the filler wire is cored. As shown in FIGS. 3A and 3B, filler material 141 forms a sheath around a core filled with flux 144. In this exemplary embodiment, the diamonds crystals 142 and/or diamond powder 143 can be mixed or embedded in the flux 144 instead of (or in addition to) the filler material 141. In other embodiments of the present invention, the flux 144 is not included in the wire 140A, and only the diamond crystals 142 and/or the diamond powder 143 are present in the core material. The core material can be manufactured similar to flux materials used in arc welding cored electrodes. For example, the core can be a granular flux having a composition similar to that of existing flux cored electrodes, except that the wear resistant particles and/or powder is also added to the flux material. In further exemplary embodiments, the construction of the wire 140A is similar to that of a metal cored wire where each of the sheath 141 and the core are solid, but the core has a solid composition including the wear resistant particles (e.g., diamonds, tungsten carbide particles) as described herein. Furthermore, exemplary embodiments of the present invention are not limited to the configurations shown in the figures, such that the flux with the wear resistant particles can be an outer layer of the wire 140A which is deposited over a solid core portion. This construction is similar to that of self-shielding stick electrodes, which have a flux coated on an outer surface of a solid core.

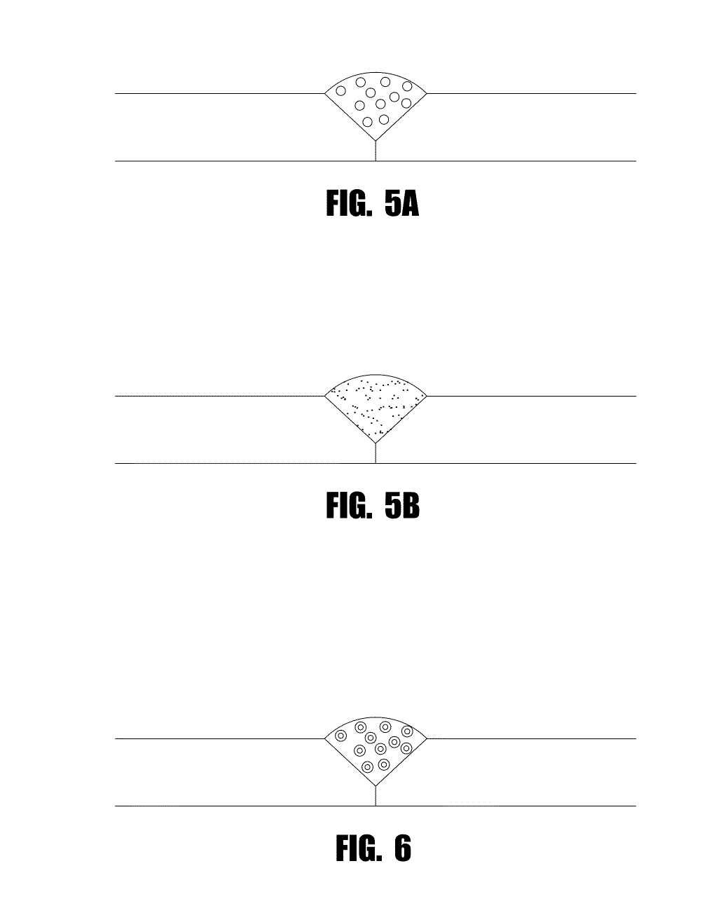

FIG. 5A illustrates a cross-sectional view of a weld wire 140C with wear-resistant material that was deposited using the filler wire illustrated in FIG. 2A or 3A. Similarly, FIG. 5B illustrates a cross-sectional view of a weld with wear-resistant material that was deposited using the filler wire illustrated in FIG. 2B or 3B. As shown in FIGS. 5A and 5B, the wear-resistant materials are found throughout the weld. Thus, as the hot-wire consumable 140A-C is deposited into the weld puddle the wear resistant particles are distributed throughout the molten puddle and when the puddle solidifies the particles are distributed throughout. It is noted that although FIGS. 5A and 5B show a typical weld joint embodiments of the present invention are not limited in this regard as the wires can also be used for cladding/surfacing operations, and can be used in other weld joint types. These figures are intended to be exemplary. For example, these figures depict exemplary weld joints and, of course, embodiments of the present invention can be used for cladding or overlaying operations without departing from the spirit or scope of the present invention. With the distribution of the wear resistant particles throughout the joint, as the joint wears down through exposure, mechanical friction, etc. the joint/deposit will consistently expose additional layers of particles such that the wear resistance of the joint/deposit is relatively consistent throughout its thickness. For example, if the filler is used in a cladding/surfacing operation as the cladding is worn away new particles are exposed, thus providing consistent wear resistant throughout the thickness of the cladding layer.

In other exemplary embodiments, processes can be used such that the wire 140A-C is used at the end of the fill process such that only the top layer (i.e., the last pass of the weld bead) or layers will include the wear-resistant materials.

Of course, the wear-resistant materials (e.g., diamonds, tungsten carbide, aluminides, etc.) and the filler material need not be included in the same filler wire 140A-C. Because an arc is not used to transfer the filler wire 140 to the weld puddle 145, the feeder subsystem 150 can be configured to simultaneously provide more than one wire to the puddle at the same time, in accordance with certain other embodiments of the present invention. (Reference herein to the wire 140 is intended to be inclusive of all of the embodiments, e.g., 140A/C, of the wire disclosed herein.) For example, a first wire may be used for depositing the wear-resistant materials (e.g., the diamond crystals 142 or diamond powder 143) to the workpiece 115, and a second wire may be used to add structure to the workpiece. The first or second wire (or additional wires) may also be used for hard-facing and/or providing corrosion resistance to the workpiece 115. In addition, by directing more than one filler wire to any one weld puddle, the overall deposition rate of the weld process can be significantly increased without a significant increase in heat input. Thus, it is contemplated that open root weld joints can be filled in a single weld pass. Further, in other exemplary multi-wire embodiments one of the wires (for example the leading wire) can deposit the matrix of the weld joint while any additional wires adds the wear resistant particles as described herein. Such embodiments can provide the ability to customize or tailor the bead profile or chemistry to provide a desired performance for specific conditions.

As discussed above, the filler wire 140A/C is melted into the weld puddle 145 without an arc. Thus, the wire 140A/C does not experience the extreme heat of the arc, which can be as high as 8,000° F. However, the melting temperature of the filler wire 140A/C will vary depending on the size and chemistry of the wire 140A/C and can exceed 1,500° F. Accordingly, in some exemplary embodiments of the present invention, the wear resistant particles are to have a melting/burning temperature higher than that of the remaining filler wire composition. This aids in ensuring that the wire melts before the integrity of the wear resistant particles is compromised. However, to the extent the wear-resistant materials are included in a filler wire having a melting temperature higher than that of the particles (or the puddle temperature will be higher than the melting/burning temperature of the particles) the particles within the filler wire 140A/C may need to be protected based on the melting temperature of the filler wire 140A/C.

For example, some exemplary embodiments discussed above use diamonds as the wear resistant material. Diamonds can burn in the presence of oxygen and form carbon dioxide. In air, which is about 21% oxygen, diamonds will burn at about 1,550° F. Accordingly, in situations where the temperature of the weld puddle 145 and/or the melting point of the wire 140A/C exceeds the temperature at which a diamond burns, care must be taken to not expose any diamonds in the filler wire 140A/C to oxygen.

In some exemplary embodiments, the filler wire 140A/C can include a flux that protects the weld area from oxidation. In such embodiments, the flux may form a protective slag over the weld area to shield the weld area from the atmosphere and/or form carbon dioxide to protect the weld area. Such a flux coating is generally known and often used with self-shielding electrodes. In some exemplary embodiments, the flux is a coating (not shown) on the filler wire. In other embodiments, the flux is disposed in the core of the filler wire as illustrated in FIGS. 3A and 3B. The compositions of such fluxes are generally known and will not be discussed herein. In other exemplary embodiments, the system 100 can include a shielding gas system which delivers a shielding gas to the puddle 145 during the operation to shield the operation from the atmosphere. The shielding gas can be an inert gas, such as argon, and can generally use known shielding gases that do not contain oxygen.

In other exemplary embodiments, the wear resistant particles 142 (for example, diamonds) can be coated to isolate the particle from any oxygen that may be present, or to isolate the particle from the heat of the puddle 145 and/or the heating of the wire. Of course, the powder 143 can also be coated. For example, as illustrated in FIG. 4, the diamond crystals 142 are coated or encapsulated using an appropriate coating 146. In some exemplary embodiments, the coating 146 may be a metal alloy such as nickel. In some embodiments, the coating 146 is selected such that its melting temperature is above the melting temperature of the filler material 141 and/or the weld puddle 145. Accordingly, because the coating 146 will not melt in these embodiments, the particles 142 will not be exposed to the atmosphere during the welding process. Alternatively, in other embodiments, the coating 146 will melt only after the filler wire 140 (140A) makes contact with the weld puddle 145, which is maintained at a temperature that is above the melting point of the coating 146. Because the particles 142 are already in the weld puddle 145 before the coating 146 melts, the exposure to the atmosphere and thus any burning of the graphite is limited. Of course, flux and inert gas may also be used to further limit the particles' exposure to the atmosphere by displacing or consuming any oxygen around the weld puddle 145.

Further, the coating acts as a thermal barrier to inhibit heat from the puddle 145 and the heating of the wire from reaching the particles. As such, the coating 145 can be a material and a thickness which provides a thermal barrier that protects the wear resistant particles. That is, in some embodiments the coating 146 can be a composition that resists the transfer of heat such that the puddle cools and solidifies before the particles are destroyed by the heat. Further, the coating 146 can be of a thickness and composition such that least some of the coating 146 melts and is absorbed into weld puddle, but at least some of the coating 146 remains on the particles as the puddle cools. Thus, the coating 146 can be of a composition that is compatible with the puddle 145 but also inhibits the heat from the puddle and in the wire 140 from destroying the wear resistant particles. As stated above, such a material can be nickel or a nickel alloy which is deposited onto the particles before the particles are combined with the wire 140. Various manufacturing methods can be used to coat the particles, including using vapor deposition, or other similar coating methods. FIG. 6 illustrates a cross-sectional view of a weld with coated wear-resistant material that was deposited using the filler wire illustrated in FIG. 4.

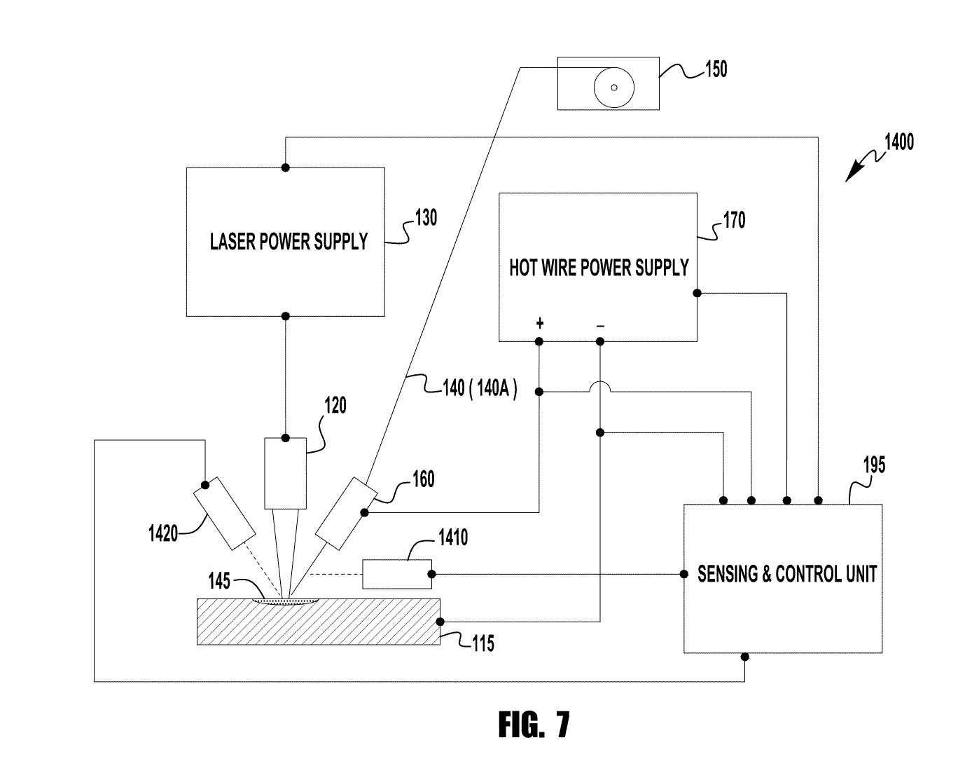

In the above embodiments, the temperature of the wire 140A/C and/or the weld puddle 145 can be an important operational parameter depending on the type of wear-resistant material being deposited. Accordingly, in yet another exemplary embodiment of the present invention as illustrated in FIG. 7, a system 1400 includes a thermal sensor 1410 that is utilized to monitor the temperature of the wire 140 (140A, 140C). The system 1400 is similar to the system 100 and, for brevity, only the relevant differences will be discussed. The thermal sensor 1410 can be of any known type capable of detecting the temperature of the wire 140. The sensor 1410 can make contact with the wire 140 or can be coupled to the tip of contact tube 160 so as to detect the temperature of the wire. In a further exemplary embodiment of the present invention, the sensor 1410 is a type which uses a laser or infrared beam which is capable of detecting the temperature of a small object—such as the diameter of a filler wire—without contacting the wire 140. In such an embodiment the sensor 1410 is positioned such that the temperature of the wire 140 can be detected at the stick out of the wire 140—that is at some point between the end of the tip of contact tube 160 and the weld puddle 145. The sensor 1410 should also be positioned such that the sensor 1410 for the wire 140 does not sense the temperature of weld puddle 145.

The sensor 1410 is coupled to a sensing and control unit 195 such that temperature feed back information can be provided to the power supply 170, the laser power supply 130, and/or wire feeder 150 so that the control of the system 1400 can be optimized. For example, the power or current output of the power supply 170 can be adjusted based on at least the feedback from the sensor 1410. That is, in an embodiment of the present invention either the user can input a desired temperature setting (for a given weld and/or wire 140) or the sensing and control unit 195 can set a desired temperature based on other user input data (type of wear-resistant material, coating of wear-resistant material, wire feed speed, electrode type, etc.) and then the sensing and control unit 195 would control at least the power supply 170, laser power supply 130, and/or wire feeder 150 to maintain that desired temperature.

In such an embodiment it is possible to account for heating of the wire 140 that may occur due to the laser beam 110 impacting on the wire 140 before the wire 140 enters the weld puddle 145. In embodiments of the invention the temperature of the wire 140 can be controlled only via power supply 170 by controlling the current in the wire 140. However, in other embodiments at least some of the heating of the wire 140 can come from the laser beam 110 impinging on at least a part of the wire 140. As such, the current or power from the power supply 170 alone may not be representative of the temperature of the wire 140. As such, utilization of the sensor 1410 can aid in regulating the temperature of the wire 140 through control of the power supply 170, the laser power supply 130 and/or wire feeder 150.

In a further exemplary embodiment (also shown in FIG. 7) a temperature sensor 1420 is directed to sense the temperature of the weld puddle 145. In this embodiment the temperature of the weld puddle 145 is also coupled to the sensing and control unit 195. However, in another exemplary embodiment, the sensor 1420 can be coupled directly to the laser power supply 130. Feedback from the sensor 1420 can be used to control output from laser power supply 130/laser 120. That is, the energy density of the laser beam 110 can be modified to ensure that the desired weld puddle temperature is achieved.

In FIGS. 1 and 7 the laser power supply 130, hot wire power supply 170, wire feeder 150, and sensing and control unit 195 are shown separately for clarity. However, in embodiments of the invention these components can be made integral into a single welding system. Aspects of the present invention do not require the individually discussed components above to be maintained as separately physical units or stand alone structures.

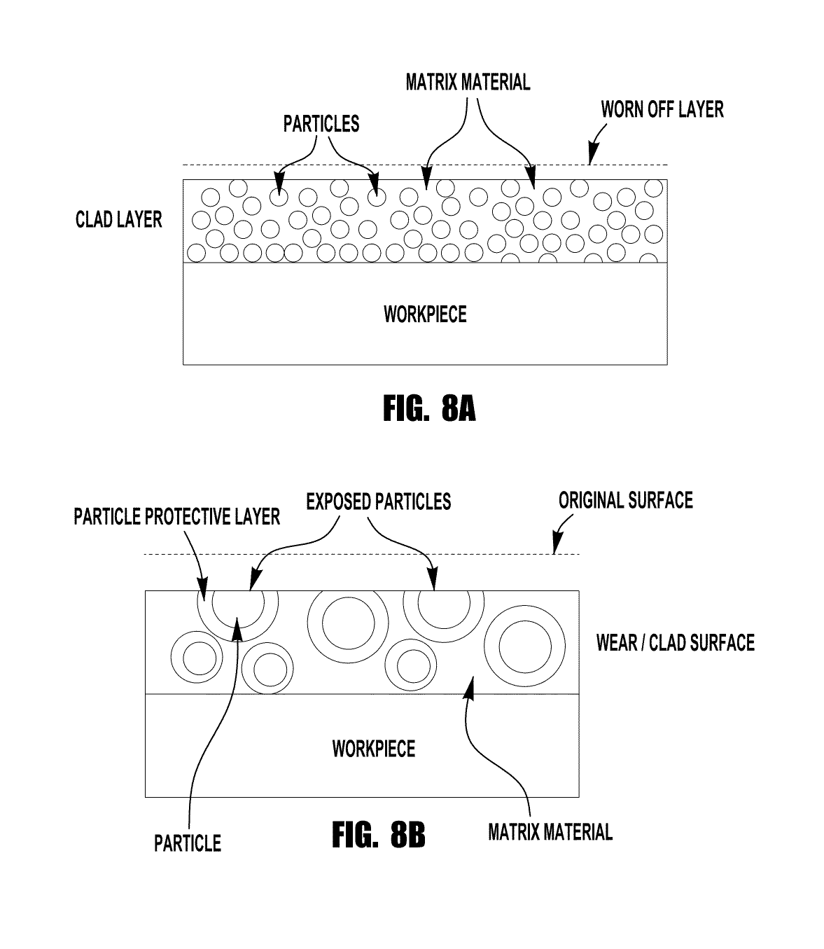

FIGS. 8A and 8B depict exemplary cladding layers that can be created with embodiments of the present invention. FIG. 8A shows a cladding layer on a workpiece with the particles distributed throughout the matrix. As shown, as the cladding layer is worn new particles are continuously exposed such that the cladding layer can provide wear resistance throughout the entire thickness of the cladding layer. Similarly, FIG. 8B shows a similar clad layer where the particles are covered by the particle protective layer (as described herein), and as the clad surface and protective layers are worn away the particles become exposed.

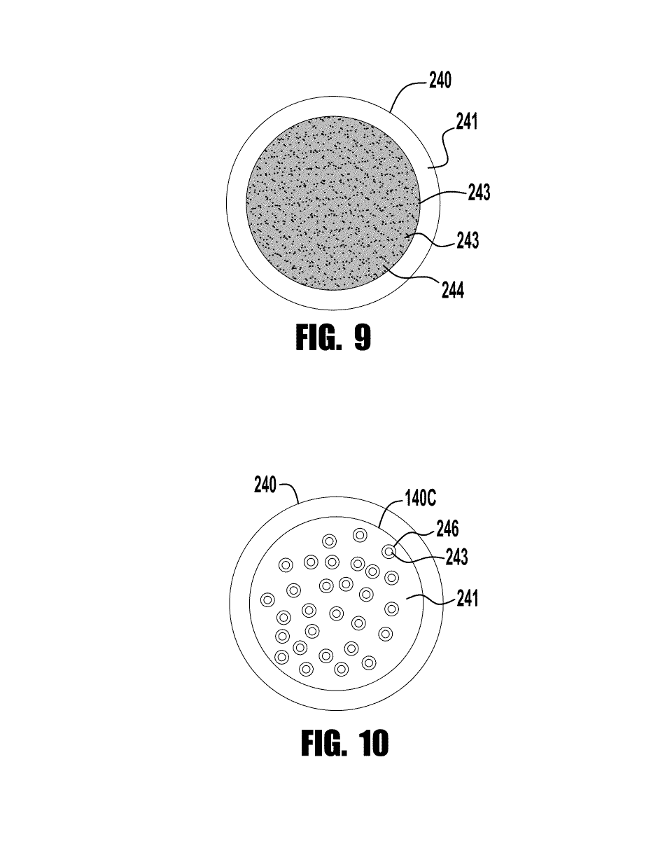

In another exemplary embodiment, the wear-resistant material is composed of material with no crystalline structure, e.g., amorphous powders. With amorphous powders, such as amorphous metallic powders, the absence of grain boundaries allows for better resistance to wear and corrosion. As shown in FIG. 9, the filler wire 240 is composed of a sheath 241 and a core 242. Exemplary applications for the filler wire 240 include hard-facing and cladding applications, but embodiments of the present invention can be also be used in welding/joining applications. The sheath 241 is composed of metal and can include, e.g., low-carbon steel, a nickel alloys, a stainless alloys, other steel alloys, copper alloys, etc. The core 242 contains amorphous powder 243, which can include, e.g., amorphous metallic powders such as iron, steel, nickel, aluminum, lanthanum, magnesium, zirconium, palladium, copper, titanium, boron, etc. and alloys thereof. The core 242 can also contain other materials 244 that can be any standard filler material that is appropriate for the application, such as, e.g., flux materials, iron, etc. The amorphous powder 243 does not have crystalline structures, and can have a nominal diameter in the range of, e.g., 10 nanometers to 50 micrometers. Of course, other diameter sizes can be used without departing from the scope of the present invention, so long as the amorphous powder 243 can be deposited and provide the desired performance. In addition, the density of the amorphous powder 243 can be important. For example, in the case where the weld matrix material is mostly iron, amorphous iron can be desirable, as amorphous iron would be evenly distributed in the weld puddle 145. Of course, based on the desired distribution characteristic, densities that are different from the weld matrix density can be used. For example, amorphous powders 243 that are less than the weld matrix density could concentrate at the top of the finished weld or cladding, which may be desirable in hard-facing applications. The filler wire 240 can be a flux-core wire or metal-core wire.

In some embodiments, the volume percentage of the amorphous powder 243 in the final deposited material, including the sheath material, can be in a range of 10% to 85%. The amount of amorphous powder 243 in the wire 240 will depend on the application. For example, for a workpiece that is exposed to a highly abrasive environment, the volume percentage in the final deposited material of amorphous powder 243 can be, e.g., 60% to 85% while a low abrasive environment can mean a volume percentage that is, e.g., 10% to 40% and a volume percentage of, e.g., 40% to 60% for a moderately abrasive environment.

In some embodiments, the amorphous powder 243 has a hardness that can be as high as 1400 Vickers Hardness Number (VHN). However, if the amorphous powers melt, the powders will start to crystallize as they cool and thus, will lose some of their wear and corrosion resistance characteristics. In addition, the melted powders could form new structures if they interact with the other material in the molten puddle. Thus, similar to the embodiments discussed above, when used in applications such as, e.g., hard-facing, cladding, joining/welding, etc. the amorphous powders have to survive intact or nearly intact to keep their desired characteristics.

Similar to the filler wire 140 discussed above, the filler wire 240 can be used in the hot wire system of FIG. 1. The wire 240 can be heated by hot wire power supply 170 to a desired temperature as the wire feeder feeds the filler wire 240 to the molten puddle 145 created by laser beam 110 (or another high intensity energy source, including arc-type sources such as PAW, GTAW, GMAW, FCAW, SAW, etc.). Because an arc is not used to transfer the wire 140 to the molten puddle 145, the amorphous powder 243 can survive if the melting temperature of the amorphous powder 243 is higher than the molten puddle 145 or if the matrix material around powder 243 is cooled quickly such that the amorphous powder 243 does not melt (or does not melt appreciably).

Of course, the melting temperature of the filler wire 240 can vary depending on the size and chemistry of the wire 240. But, in some exemplary embodiments, the amorphous powder 243 can include amorphous metallic powders such as iron, steel, nickel, aluminum, lanthanum, magnesium, zirconium, palladium, copper, titanium, boron, etc. and alloys thereof, which can have melting temperatures of approximately 1200° F. to 3800° F., depending on the metal or alloy. Accordingly, depending on the application, in some exemplary embodiments of the present invention, the amorphous powders 243 have a melting temperature higher than that of the remaining filler wire composition and that of the weld puddle 145. This aids in ensuring that the amorphous powers 243 do not melt and stay intact such that the wear and corrosion resistance characteristics are not compromised. However, to the extent the amorphous powder 243 is included in a filler wire having a melting temperature higher than that of the amorphous powder 243 (or the puddle temperature will be higher than the melting temperature of the amorphous powder 243) the amorphous powder 243 within the filler wire 240 may need to be protected based on the melting temperature of the filler wire 240.

For example, in some situations the temperature of the weld puddle 145 and/or the melting point of the wire 240 exceeds the temperature at which the amorphous powder 243 melts, e.g., approx. 1200° F. to 3800° F. depending on the amorphous metal or alloy that is used, e.g., iron, steel, nickel, aluminum, lanthanum, magnesium, zirconium, palladium, copper, titanium, boron, etc. and alloys thereof. In those situations, care must be taken to not expose the amorphous powder 243 to the high heat of the weld puddle 240 for a prolonged period of time. Accordingly, in some exemplary embodiments, the amorphous powder 243 can be coated to isolate the amorphous powder 243 from the heat of the puddle 145 and/or the heating of the wire 240. For example, as illustrated in FIG. 10, the amorphous powder 243 is coated or encapsulated using an appropriate coating 246. In some embodiments, the coating 246 is selected such that its melting temperature is above the melting temperature of the filler material 241 and/or the weld puddle 145. Accordingly, because the coating 246 will not melt in these embodiments, the coating can act as a thermal barrier to inhibit heat from the puddle 145 and the heating of the wire 240 from reaching the amorphous powder 243. To this end, the coating 246 can be a material and a thickness which provides a thermal barrier that protects the amorphous powder 243. That is, in some embodiments, the coating 246 can be a composition that resists the transfer of heat such that the puddle 145 cools and solidifies before the amorphous powder 243 is melted (or melted significantly) by the heat. Further, the coating 246 can be of a thickness and composition such that least some of the coating 246 melts and is absorbed into weld puddle 145, but at least some of the coating 246 remains on the amorphous powder 243 as the puddle 145 cools. Thus, the coating 246 can be of a composition that is compatible with the puddle 145 but also inhibits the heat from the puddle 145 and in the wire 240 from destroying the amorphous powder 243. In some exemplary embodiments, depending on the application, the coating material can be iron based, copper based, aluminum based, nickel based or alloys thereof to name just a few. The coating 246 is deposited onto the amorphous powder 243 before the amorphous powder 243 is combined with the wire 240. Various manufacturing methods can be used to coat the particles, including using vapor deposition, or other similar coating methods. The coating thickness on the amorphous powder 243 can be in a range from 5% to 100% of particle size. The actual thickness will depend on the particle being used, its size, the matrix being used and the processing parameters.

In addition, to the extent all the coating melts or the amorphous powder 243 must remain uncoated, the nominal diameter of the amorphous powder 243 can be such that only larger size particles are used, e.g., nominal diameters in a range from 1 to 50 micrometers. Thus, if the heat of the weld puddle 145 starts to melt the amorphous powder 243, by using the larger size particles, the melting can be limited to the edges of the particles. Of course, whenever possible, the amorphous powder 243 and the weld matrix material should be selected such that they are compatible so that carbides or other brittle structures do not form if the amorphous powder 243 melts or “decomposes.”

In the above embodiments, the temperature of the wire 240 and/or the weld puddle 145 can be an important operational parameter. In general, a process that provides minimal heat input to the weld puddle 145 is desired, as a lower temperature will minimize the amount of melting and/or conversion of the amorphous powder 243 from an amorphous state to a crystalline state. To this end, a hot wire process, as illustrated in FIG. 1, helps minimize the heat input into the weld puddle 145. Of course the hot wire process is not limited to a tandem laser combination and can include arc-type high energy heat sources such as PAW, GTAW, GMAW, FCAW, SAW, etc. In addition, in some arc-type embodiments where the arc electrode is a consumable electrode, the heat input can be minimized by using a short arc process such as, e.g., short arc transfer, surface tension transfer, etc. Further, as discussed above with respect to FIG. 7, the sensing and control unit 195 can control the power supply 170, laser power supply 130, and/or wire feeder 150 to maintain a desired temperature of wire 240 and/or weld puddle 145 in order to minimize the amount of melting and/or conversion of the amorphous powder 243.

While the invention has been described with reference to certain embodiments, it will be understood by those skilled in the art that various changes may be made and equivalents may be substituted without departing from the scope of the invention. In addition, many modifications may be made to adapt a particular situation or material to the teachings of the invention without departing from its scope. Therefore, it is intended that the invention not be limited to the particular embodiments disclosed, but that the invention will include all embodiments falling within the scope of the present application.

1. A hot-wire consumable, the consumable comprising:
a sheath surrounding a core;
base filler material; and
wear-resistant materials comprising amorphous metallic powder in a range of 10% to 85% of a volume of deposited materials.
